(19) United States
(12) Patent Application Publication
(10) Pub. No.: US 2012/0177111 A1
(43) Pub. Date: Jul. 12, 2012

(54) EFFICIENT CLIPPING

(76) Inventor: Matthias Narroschke, Langen (DE)

(21) Appl. No.: 13/005,095

(22) Filed: Jan. 12, 2011

(51) Int. Cl. H04N 7/32; H04N 7/12

(52) U.S. Cl. 375/240.12; 375/240.27; 375/E07.027; 375/E07.243; 375/E07.19

(57) ABSTRACT

A method for clipping pixel values of image and video data, and a method and an apparatus for encoding and decoding video data is provided. During the encoding and decoding process of video data, pixels are identified that are outside a certain range of allowable values. These out-of-scope pixels are corrected by replacing their original value with a replacement value within said range, i.e., by either the minimum or the maximum value of said range. In addition, pixels in the neighborhood of the out-of-scope pixels are corrected as well, even if their value is within the allowable range, in order to account for inter-pixel correlations. The correction of neighboring pixels may be performed by adding a correction value that is computed on the basis of the difference between the original value and the replacement value of the out-of-scope pixel.

### FIELD OF THE INVENTION

The present invention relates to image and video data processing, in particular to a method for clipping pixel values, and to a method and an apparatus for encoding and decoding video data.

### BACKGROUND OF THE INVENTION

Current video coding techniques require the video signal, i.e., the luminance and chroma data of each pixel, to be restricted to a certain finite interval, typically to values between 0 and 255. In certain applications, even more restricted limitations may apply, for instance, when the video data is stored with “broadcast legal values”. In this case, the luma signal is traditionally limited to the interval [16, 235], whereas the chroma signal is limited to [16, 240].

During the encoding and decoding process, a plurality of algebraic operations is performed on the video data and it has to be made sure that the result of these operations remains within a predefined range. Conventional hybrid video coders, for instance, apply motion compensated prediction followed by transform coding and quantization of the prediction error. During reconstruction, the quantized coefficients are inverse transformed and added to the prediction signal. Due to the quantization, reconstruction errors occur so that the reconstructed signal may be outside of the allowable range of values. Similar effects, which may be referred to as an extension of dynamic range, may also be observed when certain filters are applied to the video data, including de-blocking filters, interpolation filters, etc.

A straight forward solution to this problem is to employ a clipping operation, wherein data values greater than a certain maximum allowable value are replaced with the maximum allowable value and data values less than a certain minimum allowable value are replaced with the minimum allowable value. Due to the clipping operation, data values may be stored in a memory of a certain depth. Moreover, the reconstruction error is reduced and coding efficiency enhanced.

In the article “TE10 Subtest3: Controlled Clipping” by Yu-Lin Chang et al. (Joint Collaborative Team on Video Coding, JCTVC-C146, Guangzhou, CN, 7-15 Oct. 2010) a process called “controlled clipping” is proposed, wherein minimum and maximum allowable values of predicted or reconstructed pixel values are signaled within the bit-stream. It is also reported that with controlled clipping the average bit rate may be reduced by approximately 0.5%. Significant coding gains are observed in specific sequences. For example, using controlled clipping in the BQSquare sequence results in a 3.1% bit rate reduction.

FIG. 1 is a block diagram of a conventional video decoder. The input bit-stream is decoded by entropy decoder 110 to retrieve transform coefficients, which are then subjected to an inverse discrete cosine transformation (IDCT) in IDCT unit 120 so as to obtain prediction error data e′. Previously decoded video data is employed by prediction unit 170 for generating a prediction signal ŝ. The prediction signal and the prediction error signal are then added by means of adder 130 in order to obtain a reconstructed video signal s′.

Due to reconstruction errors, the reconstructed video signal is not necessarily bounded to the range of allowable values, e.g., to [0, 255]. This is corrected by the first clipping unit 140, which computes a clipped reconstructed video signal. This is achieved, for instance, by evaluating the equation s″=min(255, max(0, s′)).

The clipped video signal s″ is then fed into loop filter 150, such as a de-blocking filter. The resulting signal s′″ is clipped again by means of the second clipping unit 160 in order to obtain output signal \tilde{s}. The second clipping unit 160 may perform the same operation as the first clipping unit, i.e. evaluate the equation \tilde{s}=min(255, max(0, S′″)).

FIG. 2 is a block diagram of a video decoder with controlled clipping. The block diagram of FIG. 2 is similar to that of FIG. 1, wherein like reference numerals denote like components, a repetition of the corresponding detailed explanation is omitted for the sake of brevity.

The decoder of FIG. 2 differs from the decoder of FIG. 1 by the entropy decoding unit 210, which is further configured for retrieving, from the input bit-stream, a minimum value a and a maximum value b of the allowable range of values. These values are fed to the first clipping unit 240 and the second clipping unit 260, which are configured for performing the clipping operation in accordance with these values, i.e., for evaluating the equations s″=min(b, max(a, s′)) and \tilde{s}=min(b, max(a, s′″)), respectively.

An example of the conventional clipping process is illustrated in FIG. 3. The left-hand side of FIG. 3 shows an exemplary 3×3 block 310 of reconstructed video data s′. The corresponding result 320 of the clipping operation is illustrated on the right hand side. In this example, only the central pixel at position (x0, y0) is outside of the allowable range of values [0, 255]. As a result of the clipping operation performed by clipping unit 240, the value of the central pixel is reduced from 265 to 255, in other words, the original value of the central pixel is replaced by the maximum allowable value. Pixels within the allowable range of values are not affected by the clipping operation.

### SUMMARY OF THE INVENTION

As mentioned above, the conventional clipping process may result in a small reduction of the mean squared error (at a given bitrate) for certain sequences. Needless to say that there is a need for even greater improvements of the coding efficiency. Therefore, it is the object of the present invention to provide a method for processing video data that allows for a more efficient video data compression. It is a further object of the present invention to provide methods for encoding and decoding video data, as well as a corresponding encoder and decoder that achieve a higher coding efficiency.

This is achieved by the features as set forth in the independent claims. Preferred embodiments are the subject matter of dependent claims.

The inventor has realized that if a certain pixel exceeds the boundaries of an allowable range of values due to reconstruction errors or other compression artifacts, it is most likely that the very same error will also affect the neighboring pixels. This effect is particularly pronounced in cases where neighboring pixels are strongly correlated, for instance in cases with coarse quantization.

Therefore, it is the particular approach of the present invention to alter not only “out-of-scope” pixels, i.e., pixels outside of the allowable range of values, but to also correct neighboring pixels, even when the neighboring pixels are well within the allowable range. The amount of correction applied to neighboring pixels may depend on the difference between the original value of the out-of-scope pixel and the value to which the out-of-scope pixel is clipped, i.e., its replacement value.

According to a first aspect of the present invention, a method for processing video data is provided. The method comprises the steps of receiving video data for a plurality of pixels, said video data comprising a pixel value for each pixel; clipping pixel values by replacing received pixel values of out-of-scope pixels with a replacement value, out-of-scope pixels being pixels having a pixel value that is not within a predefined range; and adding a correction value to neighboring pixels of an out-of-scope pixel, the correction value being computed on the basis of a difference between the received pixel value of the out-of-scope pixel and the replacement value.

According to a second aspect of the present invention, a method for video data decoding is provided. The method comprises the steps of receiving compressed video data comprising prediction error data; predicting video data from previously decoded video data; obtaining reconstructed video data by adding the prediction error data to the predicted video data; normalizing the reconstructed video data by replacing, for each pixel of the reconstructed video data, a pixel value that is not within a predefined range with a replacement value within said range; and adding a correction value to a pixel value of a first pixel, the first pixel being adjacent to a second pixel that had a pixel value not within said range, the correction value being computed on the basis of a difference between the pixel value not within said range and the replacement value.

According to a third aspect of the present invention, a method for video data encoding is provided. The method comprises the steps of receiving video data; predicting video data from previously encoded video data; computing prediction error data by quantizing a difference between the received video data and the predicted video data; and encoding the prediction error data, wherein the predicting step further comprises the step of generating locally decoded video data by decoding the previously encoded video data with a method according to the second aspect.

According to a fourth aspect of the present invention, a video data decoder for decoding compressed video data comprising prediction error data is provided. The video data decoder comprises a prediction unit configured for predicting video data from previously decoded video data; an adder configured for obtaining reconstructed video data by adding the prediction error data to the predicted video data; a clipping unit configured for normalizing the reconstructed video data by replacing, for each pixel of the reconstructed video data, a pixel value that is not within a predefined range with a replacement value within said range, wherein the clipping unit is further adapted for adding a correction value to a pixel value of a first pixel, the first pixel being adjacent to a second pixel that had a pixel value not within said range, the correction value being computed on the basis of a difference between the pixel value not within said range and the replacement value.

According to a fifth aspect of the present invention, a video data encoder for encoding input video data is provided. The video data encoder comprises a predicting unit configured for predicting video data from previously encoded video data; a quantization unit configured for computing prediction error data by quantizing a difference between the input video data and the predicted video data; an encoding unit configured for encoding the prediction error data, wherein the predicting unit further comprises a video data decoder according to the fourth aspect for generating locally decoded video data by decoding the previously encoded video data.

In the present context, the term “neighboring pixels” may refer to pixels that are adjacent to each other in a spatial and/or temporal direction. Moreover, the term “neighboring pixels” may also refer to pixels that are close to each other in a spatial and/or temporal direction, but not directly adjacent to each other. Specifically, the neighboring pixels of the out-of-scope pixel may be pixels of the plurality of pixels that are adjacent to the out-of-scope pixel in a spatial direction, in a temporal direction, or in a spatio-temporal direction.

According to a preferred embodiment of the present invention, neighboring pixels may be corrected by adding a correction value which may be computed on the basis of the difference between the original pixel value of the out-of-scope pixel and the replacement value. However, other methods for obtaining the correction value are feasible, for instance, computing the correction value on the basis of a spatial and/or temporal distance between the neighboring pixel and the out-of-scope pixel and/or on the basis of the neighboring pixel's original pixel value.

In an advantageous embodiment, the correction value is computed by applying a scaling factor to the difference between the original pixel value of the out-of-scope pixel and the replacement value.

The scaling factor for computing the correction value may be set to a predetermined value. Advantageously, the scaling factor may be obtained by decoding a syntax element of the compressed video data and setting the scaling factor in accordance with a value of said syntax element. Alternatively, the scaling factor may be set in accordance with a quantization parameter of the prediction error data. Other means for obtaining an appropriate scaling factor are conceivable.

### DESCRIPTION OF THE DRAWINGS

The above and other objects and features of the present invention will become more apparent from the following description and preferred embodiments given in conjunction with the accompanying drawings, in which:

FIG. 1 is a block diagram of a conventional video decoder;

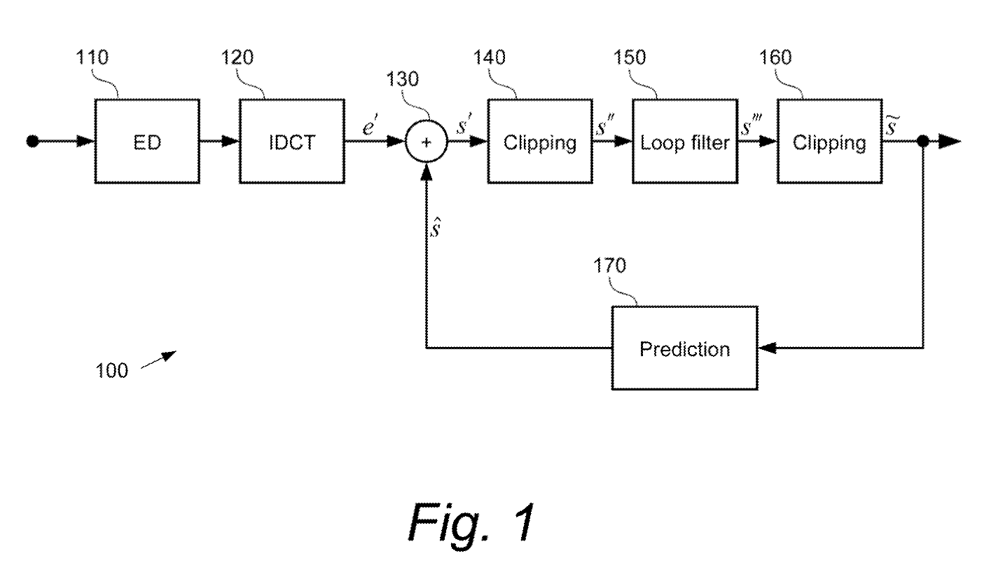

FIG. 2 is a block diagram of a video decoder with controlled clipping;

FIG. 3 is a schematic illustration of the conventional clipping process;

FIG. 4 is a block diagram of a video decoder according to an embodiment of the present invention;

FIG. 5 is a schematic illustration of the clipping process according to an embodiment of the present invention;

FIG. 6 is a block diagram of a clipping unit according to a preferred embodiment of the present invention;

FIG. 7 is a flowchart illustrating the clipping process according to a further embodiment of the present invention;

FIG. 8 is an illustration of a recording medium for storing a program realizing any of the embodiments of the present invention by means of a computer system;

FIG. 9 is a block diagram showing an overall configuration of a content supply system for realizing a content distribution service using the coding and decoding approach of the present invention;

FIG. 10 is a schematic drawing showing a cell phone for using the video/audio coding approach of the present invention;

FIG. 11 is a block diagram illustrating the functional blocks of the cell phone exemplified in FIG. 10; and

FIG. 12 is illustrating a wireless digital system for incorporating the coding and decoding approach of the present invention.

### DESCRIPTION OF THE PREFERRED EMBODIMENTS

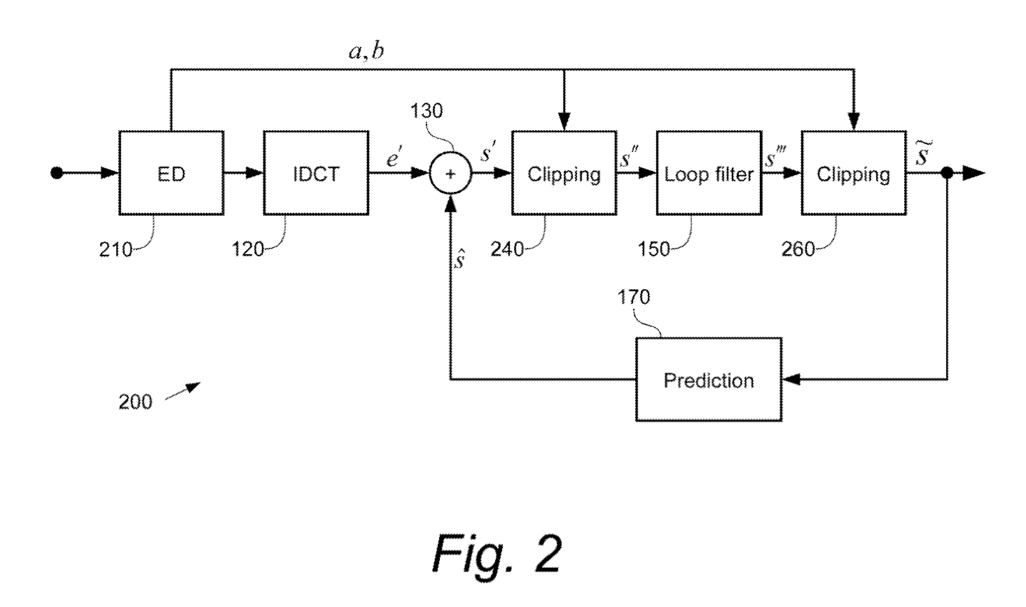

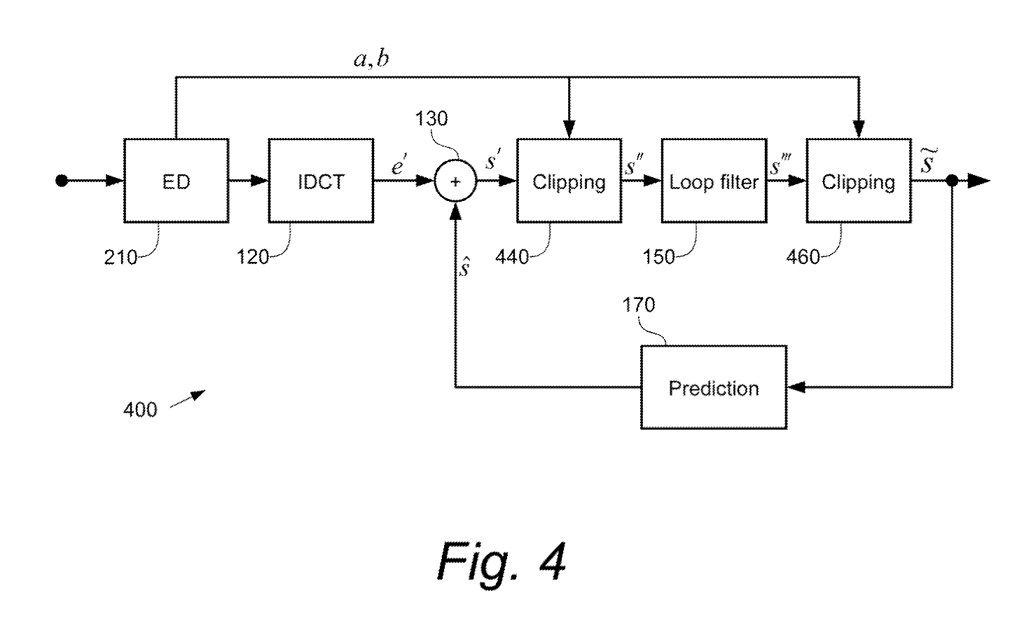

FIG. 4 is a block diagram of a video decoder according to a preferred embodiment of the present invention. The block diagram of FIG. 4 is similar to that of FIG. 2, wherein like reference numerals denote like components, a repetition of the corresponding detailed explanation is omitted for the sake of brevity.

The decoder of FIG. 4 differs from the decoder of FIG. 2 by clipping units 440 and 460, which are configured for also performing a correction of pixels in the neighborhood of out-of-scope pixels, i.e., in the neighborhood of pixels that are outside of a predefined range of allowable values.

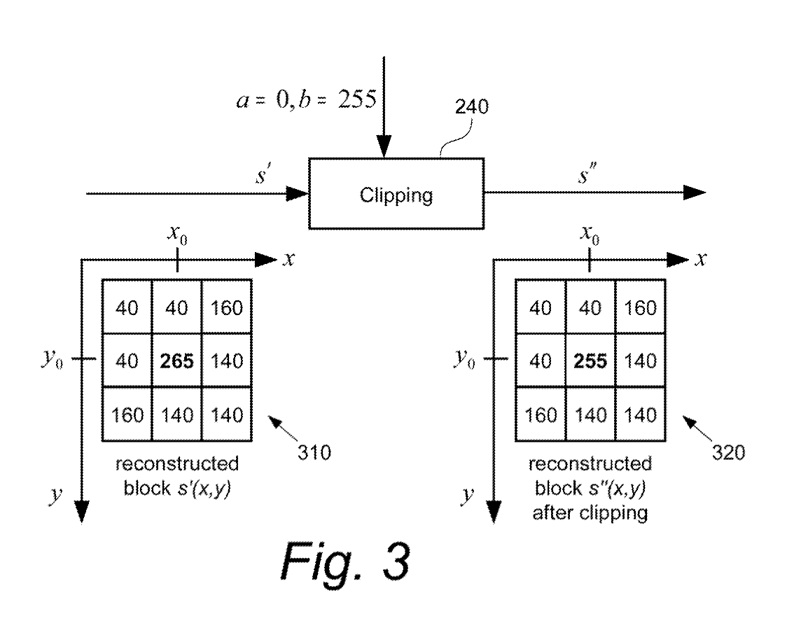

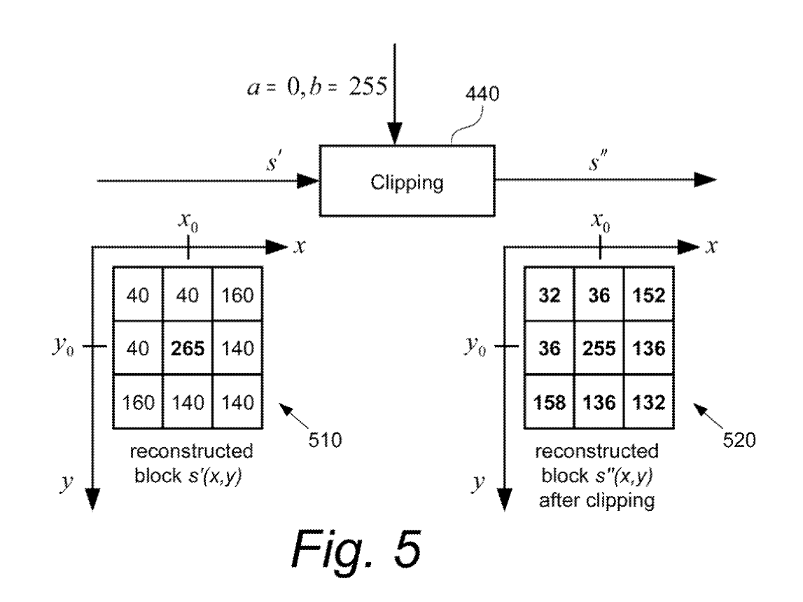

An example of the inventive clipping process is illustrated in FIG. 5. The left-hand side of FIG. 5 shows an exemplary 3×3 block 510 of reconstructed video data s′ similar to FIG. 3. The result 520 of the inventive clipping operation is illustrated on the right hand side. In this example, only the central pixel at position (x₀, y₀) is outside of the allowable range of values [0, 255]. As a result of the clipping operation performed by clipping unit 440, the value of the central pixel is reduced from 265 to 255, in other words, value of the central pixel is replaced by the maximum allowable value. In contrast to the conventional clipping process illustrated in FIG. 3, however, pixels in the neighborhood of the out-of-scope pixel at (x₀, y₀) are also modified, i.e., their values are slightly reduced.

In accordance with a preferred embodiment of the present invention, the correction of the neighboring pixels is performed by adding a correction value that is computed in accordance with a difference between the original value of the out-of-scope pixel and its replacement value, i.e., in accordance with the amplitude by which the out-of-scope pixel exceeds the allowable range of values.

More specifically, the value of the out-of-scope pixel at (x₀, y₀) in the reconstructed block is replaced by

s″(x₀,y₀)=min(b, max(a,s′(x_{0,}y₀))) (1)

and the neighboring pixels are set to

s′(x₀+m,y₀+n)=s′(x₀+m,y₀+n)+c(x₀y₀)i(m,n), (2)

with m,n=−1, 0, +1 and

c(x₀y₀)=s″(x₀y₀)−s″(x₀y₀) (3)

Here, i(m,n) is a scaling factor that determines the amount of correction applied to the neighboring pixels. In other words, pixels adjacent to an out-of-scope pixel are corrected by adding a correction value that depends on the difference between the original value s′(x₀, y₀) and the clipped value min(b, max(a, s′(x₀, y₀))) of the out-of-scope pixel. In this manner, not only pixels outside of the allowable range of values are clipped, but neighboring pixels are corrected as well.

The scaling factor i(m,n) employed for computing the amount of correction applied to neighboring pixels may be set to a fixed value, in particular to any value greater than zero and less than one. However, the scaling factor may advantageously be adapted to the statistics of the input data, in particular to the correlation between neighboring pixels.

In a preferred embodiment, the scaling factor i(m,n) is set so as to minimize the reconstruction error energy, i.e., to minimize the term

E|(s(x₀+m,y₀+n)−s″(x₀+m,y₀+n))² (4)

This leads to

$$i ( m , n ) = \frac{E \vert ( s ( {x}_{0} + m , {y}_{0} + n ) - {s}^{′} ( {x}_{0} + m , {y}_{0} + n ) ) \cdot c ( {x}_{0} , {y}_{0} ) \vert}{E \vert {c}^{2} ( {x}_{0} , {y}_{0} ) \vert} . \qquad ( 5 )$$

Hence, the weighting factor i(m,n) is dependent on the correlation of the quantization error of a neighboring pixel and the correction value c(x₀, y₀) applied to the current out-of-scope pixel. The gain is especially high in the case of high correlation. The correction value of the current pixel is a part of the quantization error of the current pixel.

In a particularly advantageous embodiment of the present invention, the weighting factor i(m,n) is determined at the encoder side and signaled to the decoder side. In this manner, the scaling factor can be adapted individually for each frame, slice, or block. Moreover, individual scaling factors may be defined for each of the plurality of neighboring pixels, depending on their spatial and/or temporal relation to the current out-of-scope pixel. Hence, the value of i(0,1), i.e., the scaling factor for the neighboring pixel to the left, may differ from the value of i(1,1), i.e., the scaling factor for the upper-left neighboring pixel.

The signaling of the scaling factors may be effected by means of dedicated syntax elements, for instance, within the sequence header, the slice header, the picture parameter set, etc.

In an alternative embodiment, the scaling factor may be determined at the decoder side only. As explained above, the correction value is advantageously computed in accordance with the correlations between neighboring pixels. The strength of these correlations is, inter alia, a function of the quantization parameter employed for quantizing the prediction error. Hence, the scaling factor may be determined, at the decoder side, as a function of the quantization parameter.

In a particularly advantageous embodiment of the present invention, an optimum scaling factor (or a set of optimum scaling factors) is determined, at the encoder side, for each of a plurality of possible quantization parameters and signaled to the decoder, for instance, by transmitting a table with the plurality of quantization parameters and the corresponding scaling factor(s). The decoder may then choose, on the basis of the received table, the optimum scaling factor(s) for correcting pixel values of a current block in accordance with the current quantization parameter.

The correction value that is added to the neighboring pixels of a current pixel that is out-of-scope may also be computed in a different manner, for instance, on the basis of the original value of the neighboring pixel itself. Specifically, the correction value may be computed in accordance with the expectation value of the neighboring pixel value, conditioned to the event that the value of the current pixel is outside of the allowable range of values, i.e, in accordance with

Eₛ_{ₐ}^{a}=E[s(xₐ+m,y₀+n)|s′(x₀y₀)<aΛs′(x₀+m,y₀+n)=s₀] (6)

and

Eₛ_{ₐ}^{b}=E[s(x₀+m,y₀+n)|s′(x₀y₀)>Λs′(x₀+,m y₀+n)=s₀] (7)

The correction value δ(m,n) may then be expressed as

$$δ ( m , n ) = \{ \begin{matrix}{E}_{{s}_{a}}^{a} - {s}^{′} ( {x}_{0} + m , {y}_{0} + n ) , & {s}^{′} ( {x}_{0} , {y}_{0} ) < a \\ {E}_{{s}_{a}}^{b} - {s}^{′} ( {x}_{0} + m , {y}_{0} + n ) , & {s}^{′} ( {x}_{0} , {y}_{0} ) > b\end{matrix} \qquad ( 8 )$$

and the correction performed on the neighboring pixels of the current out-of-scope pixel is effected in accordance with

s″(x₀+m,y₀+n)=s′(x₀+m,y₀+n)+δ(m,n). (9)

In other words, the neighboring pixel value is replaced by either one of the above conditioned expectation values, which ever is appropriate for the current out-of-scope pixel.

In a manner similar to the signaling of the optimum scaling factor(s) explained above, also the conditioned expectation values may be determined at the encoder side and transmitted to the decoder, for instance by means of dedicated syntax elements within the sequence header, the slice header, the picture parameter set, etc. As a result, the decoder can achieve a significant improvement in the correction of pixels in the neighborhood of out-scope-pixels. This translates directly into a reduction of the mean squared error and a more efficient video data compression.

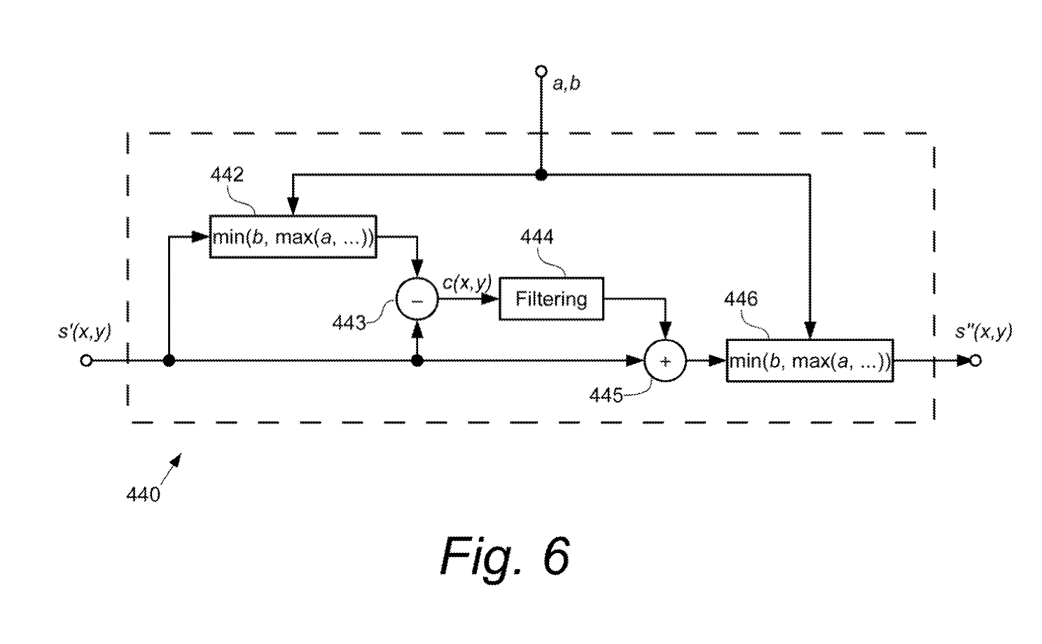

FIG. 6 is a block diagram of the clipping units 440, 460 according to a preferred embodiment of the present invention. The clipping units receive a block of input pixel data s′(x,y) and compute the differences c(x,y) between the original pixel values and the pixel values clipped to the interval [a,b] by means of limiter 442 and subtractor 443, i.e.,

c(x,y)=min(b, max(a,s′(x,y)))−^{s}′ (10)

The correction values that are to be added to neighboring pixels are computed by means of filtering unit 444 by applying filter kernel i(m,n) to the differences c(x,y), e.g. by computing a discrete convolution of c(x,y) and i(m,n) according to

$${\sum }_{m , n} c ( x - m , y - m ) i ( m , n ) . \qquad ( 11 )$$

The result of the filtering operation is then added to the original pixel values s′(x,y) in order to obtain the corrected pixel values. The actual clipping operation is then performed as a final step in limiter 446 in order to obtain the output pixel values s″(x,y), namely

$${s}^{″} ( x , y ) = min ( b , max ( a , {s}^{′} ( x , y ) + {\sum }_{m , n} c ( x - m , y - m ) i ( m , n ) ) ) . \qquad ( 12 )$$

A similar configuration may also be employed for correcting neighboring pixels in a temporal direction, such as pixels at corresponding positions in a sequence of video fields or frames. In this case, the spatial filter unit 444 with 2-dimensional filter kernel i(m,n) may be replaced by a temporal filter with a 1-dimensional filter kernel i(s). Moreover, a similar configuration may be employed for correcting both spatially and temporally neighboring pixels. In this case, the spatial filter unit 444 may be replaced by a spatio-temporal filter with a 3-dimensional filter kernel i(m,n,s). Details of the filter implementation for the filter unit 444, such as number of filter taps, etc., are a matter of design and may be selected as appropriate for the application under consideration.

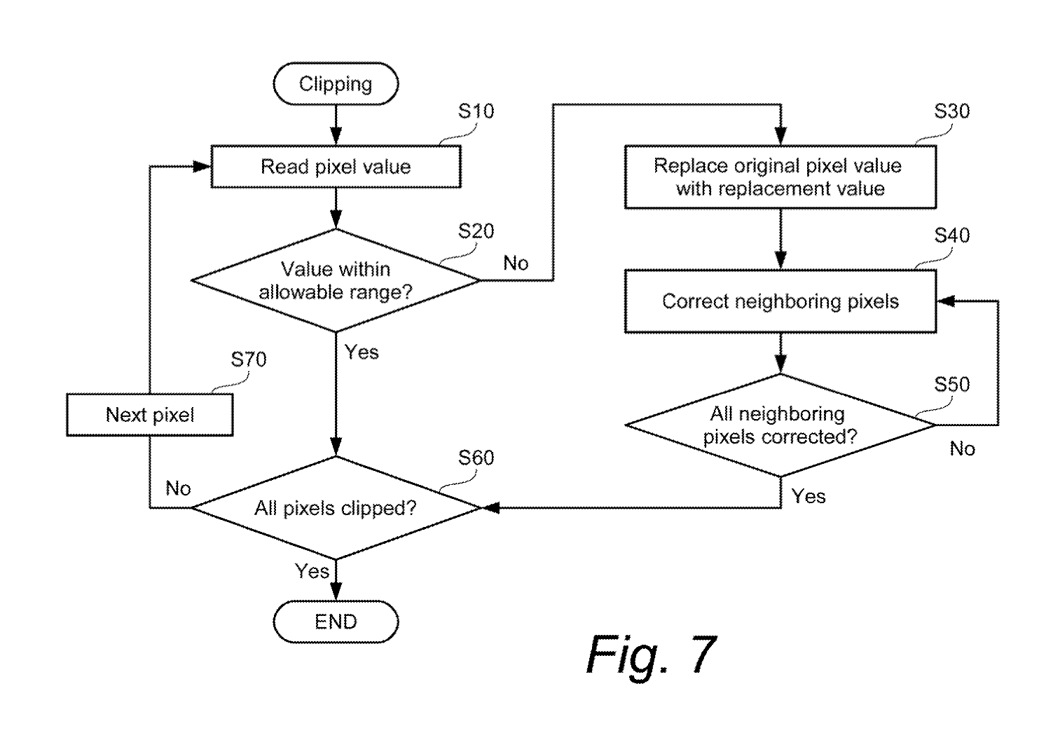

The clipping operation performed by clipping units 440, 460 may either be performed in a parallel or in a serial manner. The block diagram of FIG. 6 is an example of a parallel implementation. An example for a serial implementation is illustrated in the flow chart depicted in FIG. 7, which will be described here-below.

In step S10, the value of a first pixel with a block of pixels is read in order to determine, in step S20, whether the read value is within the allowable range of values or not. If this is the case, the current pixel is skipped and processing proceeds to the next pixel, if any (steps S60, S70). If the read value is not within the allowable range of values, the original pixel value is replaced with a replacement value in step S30, i.e., with either one of the maximum or the minimum allowable value, whichever is closer to the original value.

In step S40, neighboring pixels are corrected. As explained above, the correction may be performed by adding a correction value to the value of the neighboring pixels. Neighboring pixels may be pixels directly adjacent to the current pixel or pixels in the vicinity of the current pixel. Also, neighboring pixels may be pixels preceding or succeeding the current pixel in a sequence of video frames. Further, the correction of neighboring pixels may be restricted to pixels within a current macroblock. Further, the correction of neighboring pixels may be restricted to pixels that are within the allowable range of values, i.e., to pixels that are not subjected to the replacement operation in step S30.

The correcting step S40 may also comprise a test to ensure that performing the correction does not yield values outside of the range of allowable values. Alternatively, the entire process may be followed by a final clipping step (not shown) that replaces each pixel value outside said range with either one of the minimum or maximum allowable value, as appropriate.

When all neighboring pixels have been corrected (step S50), the process proceeds to step S60, wherein it is determined whether all pixels have been processed. If yes, processing is completed.

Depending on the particular data values, a given pixel may be a neighboring pixel of more than one out-of-scope pixels. In the embodiments of FIG. 6 and FIG. 7, the corresponding correction values simply add up. However, the present invention is not limited to this behavior. Instead, a pixel with several neighboring out-of-scope pixels may be corrected by the average of the correction values obtained from each of the neighboring out-of-scope pixels. Other methods for combining the corrections from several out-of-scope pixels may also be employed, including non-linear (saturating) functions of the sum of the individual correction values or non-linear functions of the original value of pixel that is to be corrected.

The present invention provides an improved method for clipping pixel values in image and video data compression applications. In contrast to a conventional clipping method, wherein only pixels with values outside of an allowable range of values will be affected, the present clipping method includes a correcting step for also correcting neighboring pixels that have values well within said range. In this manner, correlations between neighboring pixels are duly taken into account. Due to these correlations, reconstruction errors or other compression artifacts are unlikely to affect isolated pixels only. The fact that a certain pixel exceeds the allowable range of values may be an indication for the presence of such an artifact. Hence, correcting not only the pixel in which this artifact manifests itself, but also neighboring pixels, will lead to an improved image quality and a higher coding efficiency.

The inventive clipping method may be applied at various stages of a conventional hybrid video coder and decoder. The major source of compression artifacts necessitating a clipping operation is the quantization of the prediction error. Therefore, the inventive clipping method may be applied at all stages within the prediction loop of a conventional hybrid video decoder (and the internal decoder of the corresponding video encoder), including the stage of reconstructing the video data, i.e. adding prediction signal and prediction error signal, the deblocking filter, the loop filter, the interpolation filter, and the prediction filter, as it is generally used for intra-prediction.

The various embodiments of the invention may either be implemented by means of software modules, which are executed by a processor, or directly in hardware. Also a combination of software modules and a hardware implementation is possible. The software modules may be stored on any kind of computer readable storage media, for example RAM, EPROM, EEPROM, flash memory, registers, hard disks, CD-ROM, DVD, etc.

The present invention may in particular be embodied in form of a computer program product comprising a computer readable medium having a computer readable program code embodied thereon, the program code being adapted to carry out a method according to any of the appended claims. However, the present invention may also be embodied as an apparatus for data compression or decompression, in particular as an apparatus for video and/or audio data encoding or decoding, comprising a plurality of functional units, each of which being adapted for performing one step of a method according to any of the appended claims.

According to a further embodiment, it is possible to easily perform the processing shown in the above embodiments in an independent computing system by recording a program for realizing the coding and decoding methods shown in the above-mentioned embodiments onto the storage medium such as a flexible disk.

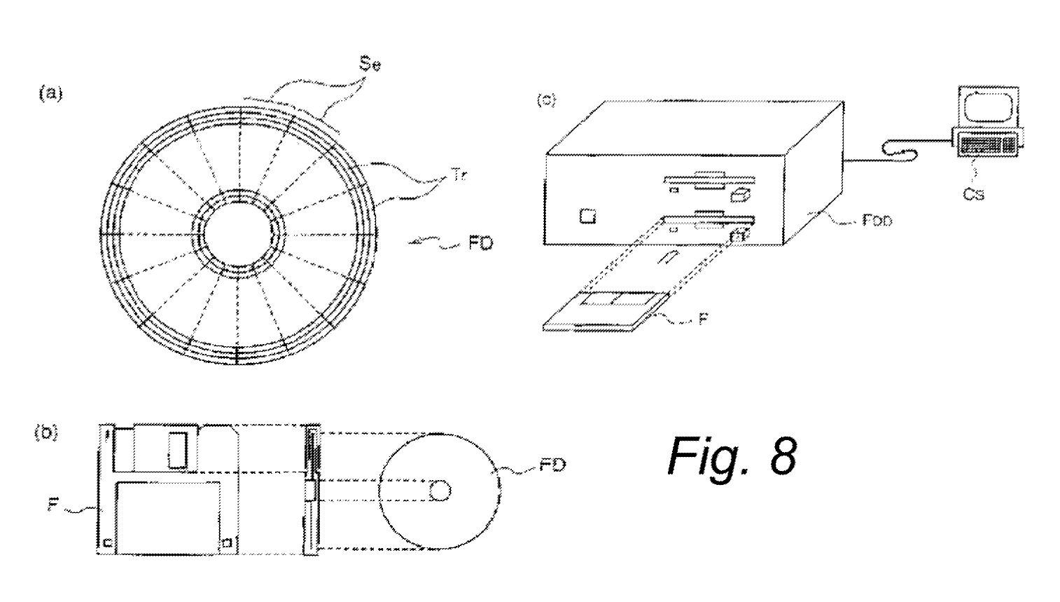

FIG. 8 is an illustration of a recording medium for storing a program for realizing any of the described embodiments by a computer system.

FIG. 8, part (b) shows a full appearance of a flexible disk, its structure at cross section and the flexible disk itself whereas FIG. 8, part (a) shows an example of a physical format of the flexible disk as a main body of a storing medium. A flexible disk FD is contained in a case F, a plurality of tracks Tr are formed concentrically from the periphery to the inside on the surface of the disk, and each track is divided into 16 sectors Se in the angular direction. Therefore, as for the flexible disk storing the above-mentioned program, data as the aforementioned program is stored in an area assigned for it on the flexible disk FD.

FIG. 8, part (c) shows a structure for recording and reading out the program on the flexible disk FD. When the program is recorded on the flexible disk FD, the computing system Cs writes in data as the program via a flexible disk drive. When the coding device and the decoding device are constructed in the computing system by the program on the flexible disk, the video/audio coding method and a video/audio decoding method as the program is read out from the flexible disk drive and then transferred to the computing system Cs.

The above explanation is made on an assumption that a storing medium is a flexible disk, however, the same processing can also be performed using an optical disk. In addition, the storing medium is not limited to a flexible disk and an optical disk, but any other medium such as an IC card and a ROM cassette capable of recording a program can be used.

According to still another embodiment, the following is an explanation of the applications of the video/audio coding method as well as the video/audio decoding method as shown in the above-mentioned embodiments, and a system using them.

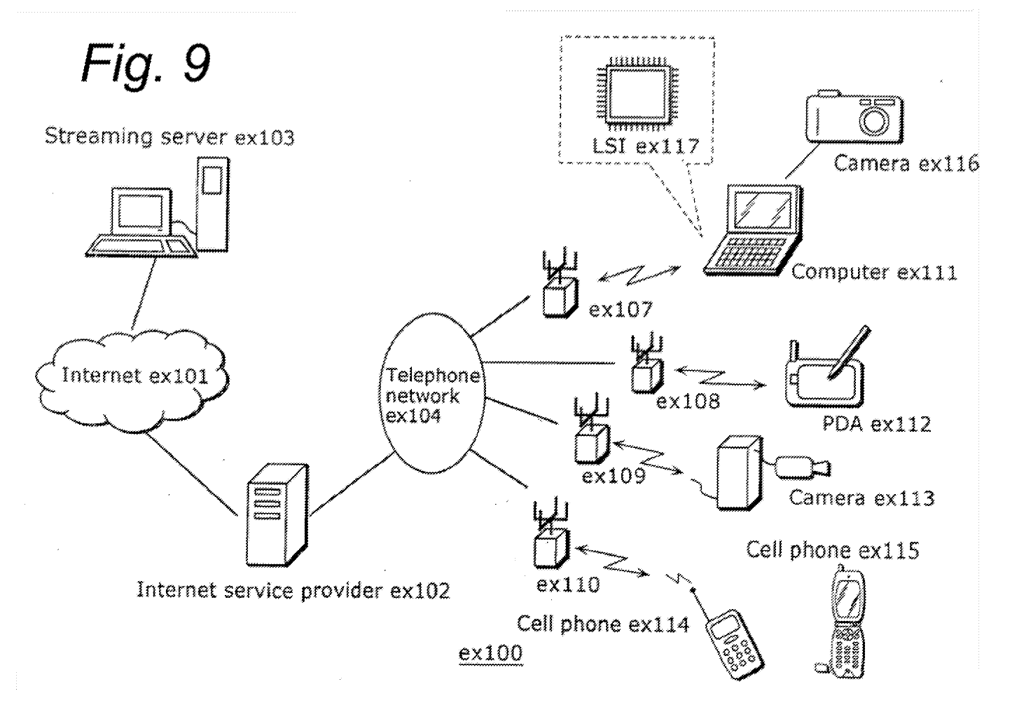

FIG. 9 is a block diagram showing an overall configuration of a content supply system ex100 for realizing content distribution service. The area for providing communication service is divided into cells of desired size, and cell sites ex107 to ex110, which are fixed wireless stations are placed in respective cells.

This content supply system ex100 is connected to devices such as Internet ex101, an Internet service provider ex102, a telephone network ex104, as well as a computer ex111, a PDA (Personal Digital Assistant) ex112, a camera ex113, a cell phone ex114 and a cell phone with a camera ex115 via the cell sites ex107 to ex110.

However, the content supply system ex100 is not limited to the configuration as shown in FIG. 9 and may be connected to a combination of any of them. Also, each device may be connected directly to the telephone network ex104, not through the cell sites ex107 to ex110.

The camera ex113 is a device capable of shooting video such as a digital video camera. The cell phone ex114 may be a cell phone of any of the following system: a PDC (Personal Digital Communications) system, a CDMA (Code Division Multiple Access) system, a W-CDMA (Wideband-Code Division Multiple Access) system or a GSM (Global System for Mobile Communications) system, a PHS (Personal Handyphone System) or the like.

A streaming server ex103 is connected to the camera ex113 via the telephone network ex104 and also the cell site ex109, which realizes a live distribution or the like using the camera ex113 based on the coded data transmitted from the user. Either the camera ex113 or the server which transmits the data may code the data. Also, the image/video data shot by a camera ex116 may be transmitted to the streaming server ex103 via the computer ex111. In this case, either the camera ex116 or the computer ex111 may code the image/video data. An LSI ex117 included in the computer ex111 or the camera ex116 actually performs coding processing. Software for video and/or audio coding and decoding may be integrated into any type of storage medium (such as a CD-ROM, a flexible disk and a hard disk) that is a recording medium which is readable by the computer ex111 or the like. Furthermore, a cell phone with a camera ex115 may transmit the image/video data. This image/video data is the data coded by the LSI included in the cell phone ex115.

The content supply system ex100 codes contents (such as a music live video) shot by a user using the camera ex113, the camera ex116 or the like in the same way as shown in the above-mentioned embodiments and transmits them to the streaming server ex103, while the streaming server ex103 makes stream distribution of the content data to the clients at their requests.

The clients include the computer ex111, the PDA ex112, the camera ex113, the cell phone ex114 and so on capable of decoding the above-mentioned coded data. In the content supply system ex100, the clients can thus receive and reproduce the coded data, and can further receive, decode and reproduce the data in real time so as to realize personal broadcasting.

When each device in this system performs coding or decoding, the data compression and decompression methods of the above-mentioned embodiments can be used.

A cell phone will be explained as an example of the device.

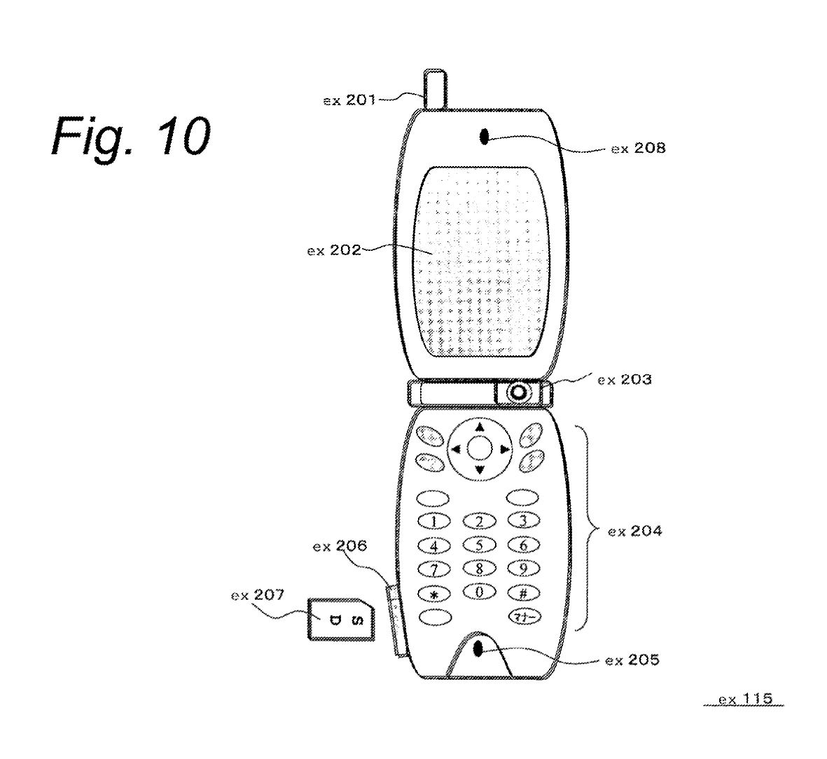

FIG. 10 is a diagram showing the cell phone ex115 using the data compression and decompression methods explained in the above-mentioned embodiments. The cell phone ex115 has an antenna ex201 for communicating with the cell site ex110 via radio waves, a camera unit ex203 such as a CCD camera capable of shooting moving and still pictures, a display unit ex202 such as a liquid crystal display for displaying the data such as decoded pictures and the like shot by the camera unit ex203 or received by the antenna ex201, a body unit including a set of operation keys ex204, a audio output unit ex208 such as a speaker for outputting audio, a audio input unit ex205 such as a microphone for inputting audio, a storage medium ex207 for storing coded or decoded data such as data of moving or still pictures shot by the camera, data of received e-mails and that of moving or still pictures, and a slot unit ex206 for attaching the storage medium ex207 to the cell phone ex115. The storage medium ex207 stores in itself a flash memory element, a kind of EEPROM (Electrically Erasable and Programmable Read Only Memory) that is a nonvolatile memory electrically erasable from and rewritable to a plastic case such as an SD card.

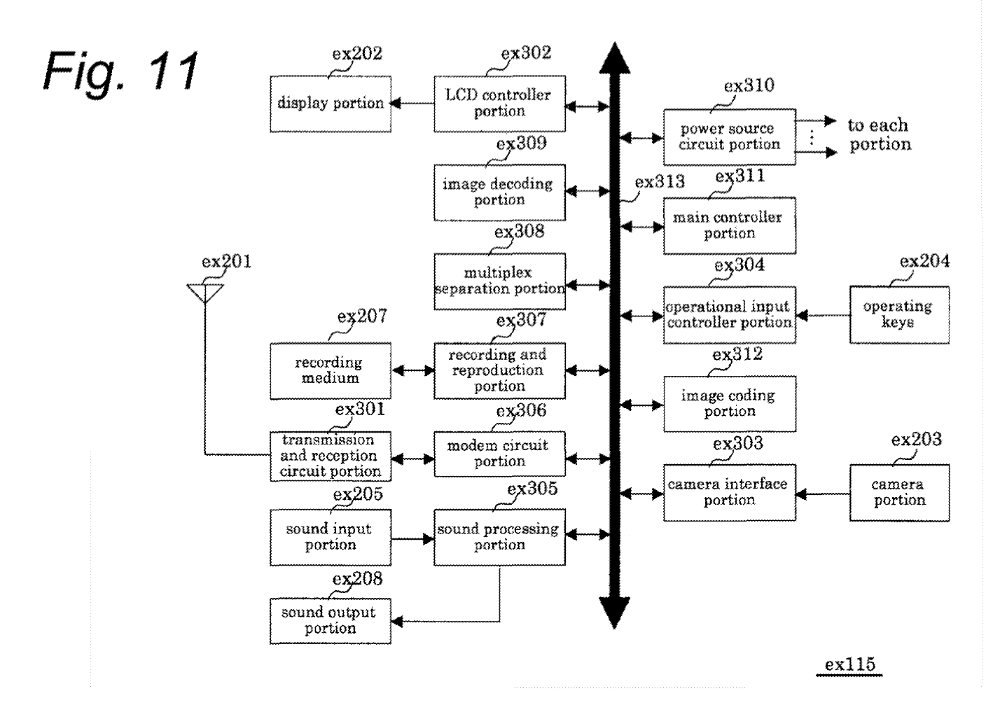

Next, the cell phone ex115 will be explained with reference to FIG. 11. In the cell phone ex115, a main control unit ex311, designed in order to control overall each unit of the main body which contains the display unit ex202 as well as the operation keys ex204, is connected mutually to a power supply circuit unit ex310, an operation input control unit ex304, a picture coding unit ex312, a camera interface unit ex303, an LCD (Liquid Crystal Display) control unit ex302, a picture decoding unit ex309, a multiplexing/demultiplexing unit ex308, a read/write unit ex307, a modem circuit unit ex306 and a audio processing unit ex305 via a synchronous bus ex313.

When a call-end key or a power key is turned ON by a user's operation, the power supply circuit unit ex310 supplies respective units with power from a battery pack so as to activate the camera attached digital cell phone ex115 as a ready state.

In the cell phone ex115, the audio processing unit ex305 converts the audio signals received by the audio input unit ex205 in conversation mode into digital audio data under the control of the main control unit ex311 including a CPU, ROM and RAM, the modem circuit unit ex306 performs spread spectrum processing of the digital audio data, and the communication circuit unit ex301 performs digital-to-analog conversion and frequency conversion of the data, so as to transmit it via the antenna ex201. Also, in the cell phone ex115, the communication circuit unit ex301 amplifies the data received by the antenna ex201 in conversation mode and performs frequency conversion and analog-to-digital conversion to the data, the modem circuit unit ex306 performs inverse spread spectrum processing of the data, and the audio processing unit ex305 converts it into analog audio data, so as to output it via the audio output unit ex208.

Furthermore, when transmitting an e-mail in data communication mode, the text data of the e-mail inputted by operating the operation keys ex204 of the main body is sent out to the main control unit ex311 via the operation input control unit ex304. In the main control unit ex311, after the modem circuit unit ex306 performs spread spectrum processing of the text data and the communication circuit unit ex301 performs digital-to-analog conversion and frequency conversion for the text data, the data is transmitted to the cell site ex110 via the antenna ex201.

When picture (video) data is transmitted in data communication mode, the picture data shot by the camera unit ex203 is supplied to the picture coding unit ex312 via the camera interface unit ex303. When it is not transmitted, it is also possible to display the picture data shot by the camera unit ex203 directly on the display unit ex202 via the camera interface unit ex303 and the LCD control unit ex302.

The picture coding unit ex312, which includes a picture coding apparatus as explained in the present invention, compresses and codes the picture data supplied from the camera unit ex203 by the coding method used for the picture coding apparatus as shown in the above-mentioned embodiment so as to transform it into coded picture data, and sends it out to the multiplexing/demultiplexing unit ex308. At this time, the cell phone ex115 sends out the audio received by the audio input unit ex205 during the shooting with the camera unit ex203 to the multiplexing/demultiplexing unit ex308 as digital audio data via the audio processing unit ex305.

The multiplexing/demultiplexing unit ex308 multiplexes the coded picture data supplied from the picture coding unit ex312 and the audio data supplied from the audio processing unit ex305 using a predetermined method, then the modem circuit unit ex306 performs spread spectrum processing of the multiplexed data obtained as a result of the multiplexing, and lastly the communication circuit unit ex301 performs digital-to-analog conversion and frequency conversion of the data for the transmission via the antenna ex201.

As for receiving data of a moving picture file which is linked to a Web page or the like in data communication mode, the modem circuit unit ex306 performs inverse spread spectrum processing of the data received from the cell site ex110 via the antenna ex201, and sends out the multiplexed data obtained as a result of the inverse spread spectrum processing.

In order to decode the multiplexed data received via the antenna ex201, the multiplexing/demultiplexing unit ex308 separates the multiplexed data into a bit stream of picture data and that of audio data, and supplies the coded picture data to the picture decoding unit ex309 and the audio data to the audio processing unit ex305 respectively via the synchronous bus ex313.

Next, the picture decoding unit ex309, including a picture decoding apparatus as explained in the present invention, decodes the bit stream of picture data using the decoding method corresponding to the coding method as shown in the above-mentioned embodiments to generate reproduced moving picture data, and supplies this data to the display unit ex202 via the LCD control unit ex302, and thus the picture data included in the moving picture file linked to a Web page, for instance, is displayed.

At the same time, the audio processing unit ex305 converts the audio data into analog audio data, and supplies this data to the audio output unit ex208, and thus the audio data included in the moving picture file linked to a Web page, for instance, is reproduced.

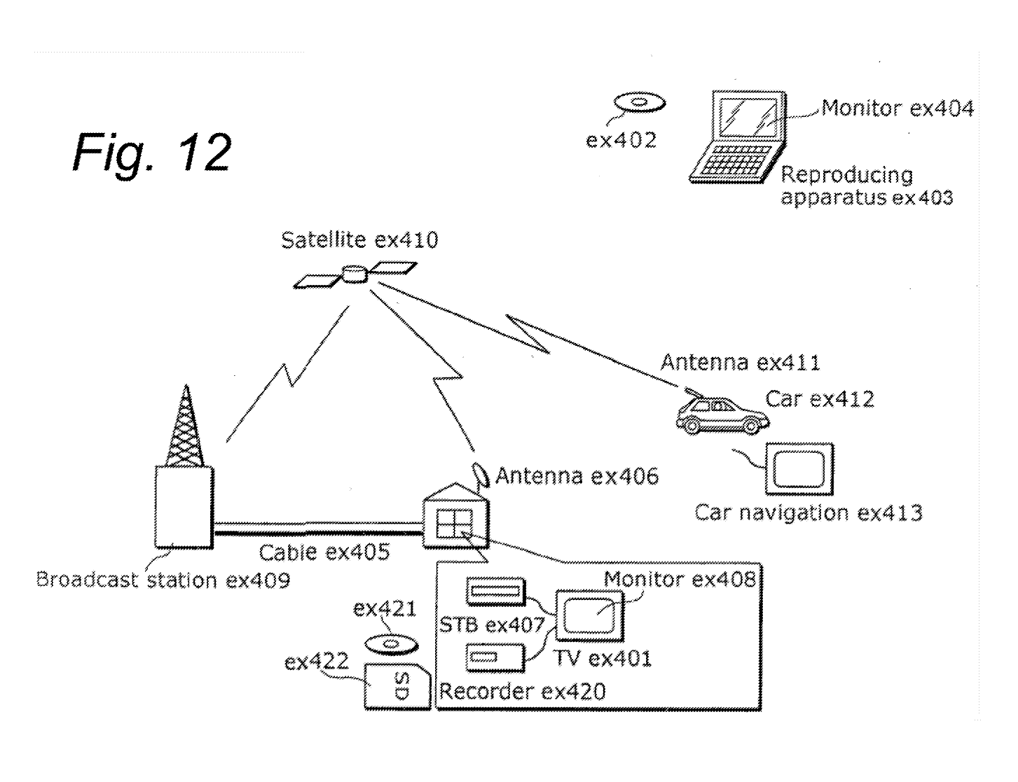

The present invention is not limited to the above-mentioned system as such ground-based or satellite digital broadcasting has been in the news lately and at least either the picture coding apparatus or the picture decoding apparatus described in the above-mentioned embodiments can be incorporated into a digital broadcasting system as shown in FIG. 12. More specifically, a bit stream of video information is transmitted from a broadcast station ex409 to or communicated with a broadcast satellite ex410 via radio waves.

Upon receipt of it, the broadcast satellite ex410 transmits radio waves for broadcasting. Then, a home-use antenna ex406 with a satellite broadcast reception function receives the radio waves, and a television (receiver) ex401 or a set top box (STB) ex407 decodes the bit stream for reproduction. The picture decoding apparatus as shown in the above-mentioned embodiment can be implemented in the reproducing apparatus ex403 for reading out and decoding the bit stream recorded on a storage medium ex402 that is a recording medium such as CD and DVD. In this case, the reproduced video signals are displayed on a monitor ex404. It is also conceivable to implement the picture decoding apparatus in the set top box ex407 connected to a cable ex405 for a cable television or the antenna ex406 for satellite and/or ground-based broadcasting so as to reproduce them on a monitor ex408 of the television ex401. The picture decoding apparatus may be incorporated into the television, not in the set top box. Also, a car ex412 having an antenna ex411 can receive signals from the satellite ex410 or the cell site ex107 for reproducing moving pictures on a display device such as a car navigation system ex413 set in the car ex412.

Furthermore, the picture coding apparatus as shown in the above-mentioned embodiments can code picture (video) signals and record them on a recording medium. As a concrete example, a recorder ex420 such as a DVD recorder for recording picture signals on a DVD disk ex421, a disk recorder for recording them on a hard disk can be cited. They can be recorded on an SD card ex422. If the recorder ex420 includes the picture decoding apparatus as shown in the above-mentioned embodiments, the picture signals recorded on the DVD disk ex421 or the SD card ex422 can be reproduced for display on the monitor ex408. As for the structure of the car navigation system ex413, the structure without the camera unit ex203, the camera interface unit ex303 and the picture coding unit ex312, out of the components shown in FIG. 11, is conceivable. The same applies for the computer ex111, the television (receiver) ex401 and others.

In addition, three types of implementations can be conceived for a terminal such as the above-mentioned cell phone ex114; a sending/receiving terminal implemented with both a coder and a decoder, a sending terminal implemented with a coder only, and a receiving terminal implemented with a decoder only. As described above, it is possible to use the methods described in the above-mentioned embodiments for any of the above-mentioned devices and systems, and by using this method, the effects described in the above-mentioned embodiments can be obtained.

Another embodiment of the invention relates to the implementation of the above described various embodiments using hardware and software. It is recognized that the various embodiments of the invention may be implemented or performed using computing devices (processors). A computing device or processor may for example be general-purpose processors, digital signal processors (DSP), application specific integrated circuits (ASIC), field programmable gate arrays (FPGA) or other programmable logic devices, etc. The various embodiments of the invention may also be performed or embodied by a combination of these devices.

Most of the examples have been outlined in relation to an H.264/AVC based video coding system or to an AAC based audio coding system, and the terminology mainly relates to the H.264/AVC and the AAC terminology, respectively. However, this terminology and the description of the various embodiments is not intended to limit the principles and ideas of the invention. Also the detailed explanations of the encoding and decoding in compliance with the H.264/AVC standard are intended to better understand the exemplary embodiments described herein and should not be understood as limiting the invention to the described specific implementations of processes and functions in the video coding. Nevertheless, the improvements proposed herein may be readily applied in the video coding described. Furthermore, the concept of the invention may be also readily used in the enhancements of H.264/AVC coding currently discussed by the Joint Video Team (JVT).

Summarizing, the present invention provides a method for clipping pixel values of image and video data, and a method and an apparatus for encoding and decoding video data. During the encoding and decoding process of video data, pixels are identified that are outside a certain range of allowable values. These out-of-scope pixels are corrected by replacing their original value with a replacement value within said range, i.e., by either the minimum or the maximum value of said range. In addition, pixels in the neighborhood of the out-of-scope pixels are corrected as well, even if their value is within the allowable range, in order to account for inter-pixel correlations. The correction of neighboring pixels may be performed by adding a correction value that is computed on the basis of the difference between the original value and the replacement value of the out-of-scope pixel.

1. A method for processing video data, said method comprising the steps of
receiving video data for a plurality of pixels, said video data comprising a pixel value for each pixel;
clipping pixel values by replacing received pixel values of out-of-scope pixels with a replacement value, out-of-scope pixels being pixels having a pixel value that is not within a predefined range; and
adding a correction value to neighboring pixels of an out-of-scope pixel, the correction value being computed on the basis of a difference between the received pixel value of the out-of-scope pixel and the replacement value.

2. A method according to claim 1, wherein the neighboring pixels of the out-of-scope pixel are pixels of the plurality of pixels that are adjacent to the out-of-scope pixel in a spatial direction.

3. A method according to claim 1, wherein the neighboring pixels of the out-of-scope pixel are pixels of the plurality of pixels that are adjacent to the out-of-scope pixel in a temporal direction.

4. A method according to claim 1, wherein the correction value is computed on the basis of the difference between the received pixel value of the out-of-scope pixel and the replacement value, and on the basis of a spatial and/or temporal distance between the neighboring pixel and the out-of-scope pixel.

5. A method according to claim 1, wherein the correction value is computed on the basis of the difference between the received pixel value of the out-of-scope pixel and the replacement value, and on the basis of a received pixel value of the neighboring pixel.

6. A method according to claim 1, wherein the correction value is computed by applying a scaling factor to the difference between the received pixel value of the out-of-scope pixel and the replacement value.

7. A method for video data decoding, said method comprising the steps of
receiving compressed video data comprising prediction error data;
predicting video data from previously decoded video data;
obtaining reconstructed video data by adding the prediction error data to the predicted video data;
normalizing the reconstructed video data by replacing, for each pixel of the reconstructed video data, a pixel value that is not within a predefined range with a replacement value within said range; and
adding a correction value to a pixel value of a first pixel, the first pixel being adjacent to a second pixel that had a pixel value not within said range, the correction value being computed on the basis of a difference between the pixel value not within said range and the replacement value.

8. A method according to claim 7, wherein the first pixel and the second pixel are adjacent to each other in a spatial direction.

9. A method according to claim 7, wherein the first pixel and the second pixel are adjacent to each other in a temporal direction.

10. A method according to claim 7, wherein the correction value is computed by applying a scaling factor to the difference between the pixel value not within said range and the replacement value.

11. A method according to claim 10, further comprising the steps of
decoding a syntax element of the compressed video data; and
setting the scaling factor in accordance with a value of said syntax element.

12. A method according to claim 10, further comprising the step of
setting the scaling factor in accordance with a quantization parameter of the prediction error data.

13. A method for video data encoding, said method comprising the steps of
receiving video data;
predicting video data from previously encoded video data;
computing prediction error data by quantizing a difference between the received video data and the predicted video data; and
encoding the prediction error data,
wherein the predicting step further comprises the step of generating locally decoded video data by decoding the previously encoded video data with a method according to claim 7.

14. A video data decoder for decoding compressed video data comprising prediction error data, the video data decoder comprising:
a prediction unit configured for predicting video data from previously decoded video data;
an adder configured for obtaining reconstructed video data by adding the prediction error data to the predicted video data;
a clipping unit configured for normalizing the reconstructed video data by replacing, for each pixel of the reconstructed video data, a pixel value that is not within a predefined range with a replacement value within said range,
wherein the clipping unit is further adapted for adding a correction value to a pixel value of a first pixel, the first pixel being adjacent to a second pixel that had a pixel value not within said range, the correction value being computed on the basis of a difference between the pixel value not within said range and the replacement value.

15. A video data decoder according to claim 14, wherein the first pixel and the second pixel are adjacent to each other in a spatial direction.

16. A video data decoder according to claim 14, wherein the first pixel and the second pixel are adjacent to each other in a temporal direction.

17. A video data decoder according to claim 14, wherein the correction value is computed by applying a scaling factor to the difference between the pixel value not within said range and the replacement value.

18. A video data decoder according to claim 17, further comprising:
a decoding unit configure for decoding a syntax element of the compressed video data,
wherein the clipping unit is further configured for setting the scaling factor in accordance with a value of said syntax element.

19. A video data decoder according to claim 17, wherein the clipping unit is further configured for setting the scaling factor in accordance with a quantization parameter of the prediction error data.

20. A video data encoder for encoding input video data, said video data encoder comprising:
a predicting unit configured for predicting video data from previously encoded video data;
a quantization unit configured for computing prediction error data by quantizing a difference between the input video data and the predicted video data;
an encoding unit configured for encoding the prediction error data,
wherein the predicting unit further comprises a video data decoder according to claim 14 for generating locally decoded video data by decoding the previously encoded video data.
